(19) United States
(12) Patent Application Publication
(10) Pub. No.: US 2015/0370517 A1
(43) Pub. Date: Dec. 24, 2015

(54) IMAGE FORMING APPARATUS, CONTROL METHOD OF IMAGE FORMING APPARATUS, AND STORAGE MEDIUM

(71) Applicant: CANON KABUSHIKI KAISHA, Tokyo (JP)

(72) Inventors: Akiko Tokumaru, Tokyo (JP); Koji Shimizu, Tokyo (JP)

(21) Appl. No.: 14/745,076

(22) Filed: Jun. 19, 2015

(30) Foreign Application Priority Data
Jun. 23, 2014 (JP) 2014-128347

(51) Int. Cl. G06F 3/12

(52) U.S. Cl. CPC G06F 3/1238; G06F 3/1204; G06F 3/1236; G06F 3/1257; G06F 3/1292

(57) ABSTRACT

An image forming apparatus that executes at least near field wireless communication with a mobile apparatus includes a storage unit that stores first setting information indicating a setting relating to reading or printing of an image for each user, a reading unit that reads user identification information indicating a user who uses the mobile apparatus and second setting information indicating a setting relating to reading or printing of an image from the mobile apparatus through the near field wireless communication, and a writing unit that writes, in the mobile apparatus, a difference between the first setting information stored in the storage unit corresponding to the user identification information read by the reading unit and the second setting information read by the reading unit.

### BACKGROUND

1. Field

Aspects of the present invention generally relate to an image forming apparatus, a control method of the image forming apparatus, and a storage medium.

2. Description of the Related Art

Conventionally, with respect to an image forming apparatus installed in a public place such as a convenience store, there has been provided a technique for executing a job by reading and using customized setting information written into an integrated circuit (IC) card without registering the customized setting information of each user on the image forming apparatus (see, Japanese Patent Application Laid-Open No. 2007-283626). With the above technique, a load of the user for executing a setting operation is reduced while the job can be promptly started.

Because the above-described conventional technique is intended for an image forming apparatus in a usage environment having unspecified number of users, the customized setting information cannot be registered on the image forming apparatus. Further, in a case where the user who has or does not have a registered IC card logs in the image forming apparatus without using the IC card, the user cannot execute a desired job by using the customized setting information.

### SUMMARY

Aspects of the present invention generally relate to providing a system enabling a user using a communication apparatus to log onto the image forming apparatus to register setting information written into the communication apparatus onto any image forming apparatus to reflect the setting information on a setting of a job to be executed.

An image forming apparatus that executes at least near field wireless communication with a mobile apparatus includes a storage unit configured to store first setting information indicating a setting relating to reading or printing of an image for each user, a reading unit configured to read user identification information indicating a user who uses the mobile apparatus and second setting information indicating a setting relating to reading or printing of an image from the mobile apparatus through the near field wireless communication, and a writing unit configured to write, in the mobile apparatus, a difference between the first setting information stored in the storage unit corresponding to the user identification information read by the reading unit and the second setting information read by the reading unit.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a system including an image forming apparatus.

FIG. 2 is a diagram illustrating an external view of the image forming apparatus illustrated in FIG. 1.

FIG. 3 is a block diagram illustrating a configuration of a controller.

FIG. 4 is a flowchart illustrating a control method of the image forming apparatus.

FIG. 5 is a flowchart illustrating a control method of the image forming apparatus.

FIG. 6 is a diagram illustrating communication connection processing executed by a mobile terminal and the image forming apparatus.

FIG. 7 is a table illustrating pairing information of the mobile terminal and the image forming apparatus.

FIGS. 8A and 8B are diagrams illustrating user interface (UI) screens displayed on an operation unit.

### DESCRIPTION OF THE EMBODIMENTS

An exemplary embodiment will be described with reference to the appended drawings.

### Description of System Configuration

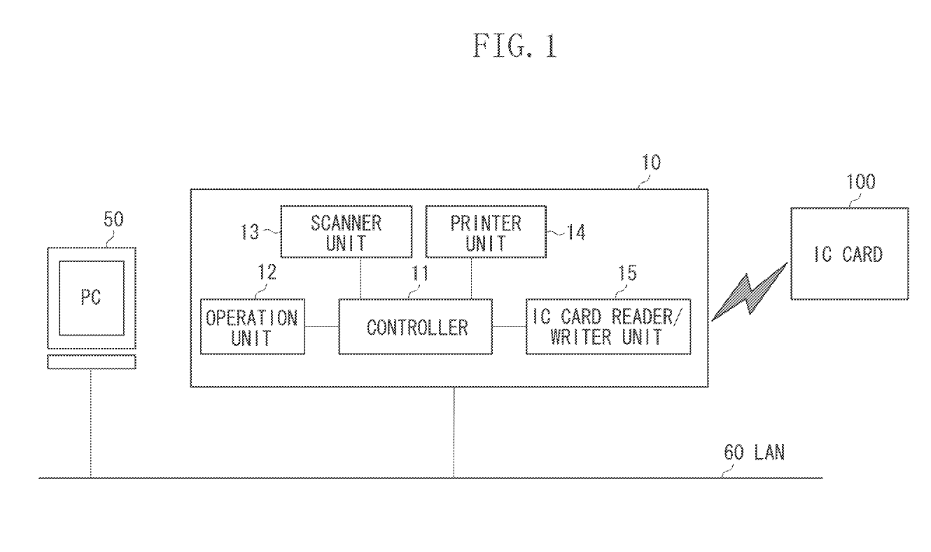

A first exemplary embodiment will be described. FIG. 1 is a block diagram illustrating a configuration of a system including an image forming apparatus according to the present exemplary embodiment. In the system according to the present exemplary embodiment, a personal computer 50 and an image forming apparatus 10 are connected to a local area network (LAN) 60. In the system, number of the personal computers and the image forming apparatuses connected thereto are not limited to the above example. Further, in the present exemplary embodiment, the LAN is employed as a connection method. However, the connection method is not limited thereto. For example, an optional network such as a public line represented by a wide area network (WAN) may be employed therefor.

In FIG. 1, the personal computer (hereinafter, referred to as “PC”) 50 can transmit and receive files and e-mails to/from the image forming apparatus 10 through the LAN 60 or the WAN by using a file transfer protocol (FTP) or a server message block (SMB) protocol. Further, the PC 50 can instruct the image forming apparatus 10 to execute printing processing through a printer driver.

Subsequently, a configuration of the image forming apparatus 10 will be described in detail.

The image forming apparatus 10 is configured of a scanner unit 13 serving as an image input device, a printer unit 14 serving as an image output device, a controller (controller unit) 11 that controls the entire operations executed by the image forming apparatus 10, an operation unit 12 serving as a user interface (UI), and an integrated circuit (IC) card reader/writer unit 15.

The IC card reader/writer unit 15 is connected to an IC card 100 that stores user information and customized setting information. In addition, the IC card 100 internally includes a storage unit for storing user information and customized setting information.

Here, a communication method of the IC card 100 and the IC card reader/writer unit 15 will be described. In the present exemplary embodiment, the IC card 100 capable of executing non-contact near field communication is used to communicate with the IC card reader/writer unit 15. However, the IC card 100 may be a magnetic card. In such a case, the IC card reader/writer unit 15 is provided with a magnetic card reader mechanism.

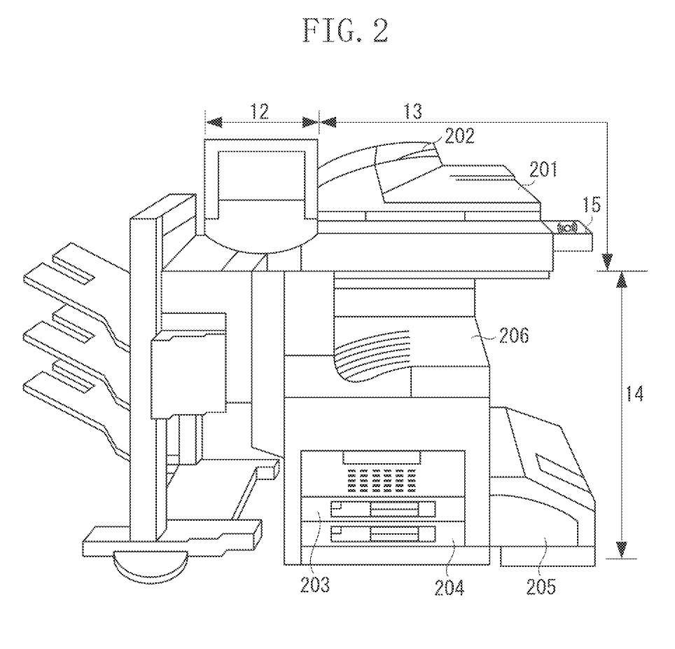

FIG. 2 is a diagram illustrating an external view of the image forming apparatus 10 illustrated in FIG. 1.

In FIG. 2, the scanner unit 13 includes a charge coupled device (CCD) and inputs the reflected light acquired by exposing and scanning an image on a document to the CCD in order to convert information of the image into electric signals. Further, the electric signals are converted into luminance signals consisting of respective colors of red (R), green (G), and blue (B), so as to output the converted luminance signals to the controller 11 as image data.

In addition, a document is placed on a tray 202 of a document feeder 201. When the user provides a reading-start instruction through the operation unit 12, the controller 11 instructs the scanner unit 13 to start reading the document. When the scanner unit 13 receives the above instruction, the document is fed thereto from the tray 202 of the document feeder 201 one by one, so that the scanner unit 13 executes a reading operation of the document. Further, a method of reading the document is not limited to an automatic feeding method using the document feeder 201, and the document may be read through a method in which the scanner unit 13 scans the document placed on a glass plate (not illustrated) by moving an exposure unit.

The printer unit 14 is an image forming device for forming an image from the image data received from the controller 11 on a sheet. In the present exemplary embodiment, an electro-photographic system using a photosensitive drum or a photosensitive belt is employed as an image forming system. However, this type of image forming system is not seen to be limiting. e. For example, an ink-jet system in which printing is executed on a sheet by discharging ink through a minute nozzle array may be also employed therefor. Further, the printer unit 14 is provided with a plurality of sheet cassettes 203, 204, and 205 for enabling a user to select different sheet sizes and different sheet orientations. A printed sheet is discharged onto a sheet discharge tray 206.

The operation unit 12 is a user interface unit having a display panel mainly configured of a liquid crystal display and an input mechanism configured of a touch panel.

The IC card reader/writer unit 15 reads user information registered on the IC card 100 dedicated to the user. The user can log in the image forming apparatus 10 by using the user information. The IC card reader/writer unit 15 can read customized setting information previously registered on the IC card 100 by the user. Further, the IC card reader/writer unit 15 can write and store the customized setting information set through the image forming apparatus 10 into the IC card 100.

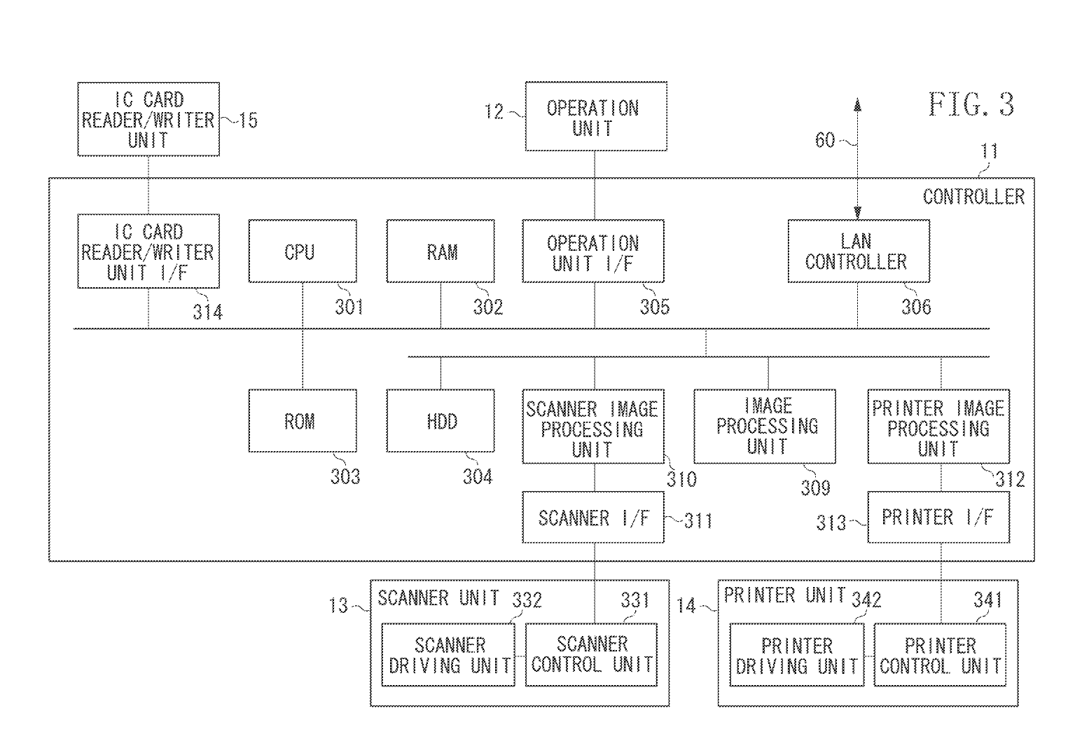

FIG. 3 is a block diagram illustrating a configuration of the controller 11 of the image forming apparatus 10 illustrated in FIG. 1 in more detail.

In FIG. 3, the controller 11 is electrically connected to the scanner unit 13 and the printer unit 14. Further, the controller 11 is connected to the PC 50 and an external apparatus via the LAN 60. With this configuration, the controller 11 can input and output image data and device information.

Based on a control program stored in a read only memory (ROM) 303, a central processing unit (CPU) 301 comprehensively controls access to various devices connected thereto while comprehensively controlling various kinds of processing executed within the controller 11. A random access memory (RAM) 302 serves as a system work memory for the CPU 301 to execute operations, and serves as a memory for temporarily storing image data. The RAM 302 is configured of a static random access memory (SRAM) and a dynamic random access memory (DRAM). A boot program for the image forming apparatus 10 is stored in the ROM 303. A hard disk drive (HDD) 304 can store system software and image data.

An operation unit interface (I/F) 305 serves as an interface unit for connecting the operation unit 12 to a system bus 307. The operation unit I/F 305 receives, from the system bus 307 image data that is to be displayed on the operation unit 12, and outputs the received image data to the operation unit 12. Further, the operation unit I/F 305 outputs the information received from the operation unit 12 to the system bus 307.

A LAN controller 306 is connected to the LAN 60 and the system bus 307 in order to control input and output of the information. Further, because the LAN controller 306 is provided with a power-receiving unit of the Power over Ethernet (PoE) (registered mark), power can be supplied thereto through a LAN cable. Therefore, the LAN controller 306 can be operated by the power supplied from the PoE in addition to the power supplied from a power source of the image forming apparatus 10. An image bus 308 serves as a transmission path for exchanging image data, and is configured of a peripheral component interconnect (PCI) bus or a bus compliant with the Institute of Electrical and Electronics Engineers (IEEE) 1394.

An image processing unit 309 is a unit for executing image processing. The image processing unit 309 can read image data stored in the RAM 302 to execute image processing such as enlargement/reduction processing or color adjustment processing of joint photographic experts group (JPEG) data or joint bi-level image experts group (JBIG) data.

A scanner image processing unit 310 corrects, processes, and edits image data received from the scanner unit 13 via a scanner I/F 311. The scanner image processing unit 310 determines whether the received image data is a color document, a black and white document, a text document, or a photographic document. Then, the scanner image processing unit 310 adds the above determination result to the image data. Such additional information is referred to as attribute data.

A printer image processing unit 312 refers to the attribute data added to the image data to execute image processing on the image data. After image processing is executed, the image data is output to the printer unit 14 via a printer I/F 313.

A scanner control unit 331 communicates with the CPU 301 to receive settings with respect to the scanner unit 13 from the user, and controls a scanner driving unit 332 based on the settings. The CPU 301 may function as the scanner control unit 331 to control the scanner driving unit 332. The scanner driving unit 332 physically operates in a manner similar to a sheet conveyance motor of an automatic document feeder (ADF) which is not illustrated. The scanner driving unit 332 operates based on the control of the scanner control unit 331.

A printer control unit 341 communicates with the CPU 301 to receive settings with respect to the printer unit 14 from the user, and controls a printer driving unit 342 based on the settings. The CPU 301 may function as the printer control unit 341 to control the printer driving unit 342. The printer driving unit 342 physically operates in a manner similar to a fixing unit or a sheet conveyance motor (not illustrated). The printer driving unit 342 operates based on the control of the printer control unit 341.

The IC card reader/writer unit 15 is connected thereto via an IC card reader/writer unit I/F 314, so as to transmit and receive information to/from the IC card 100.

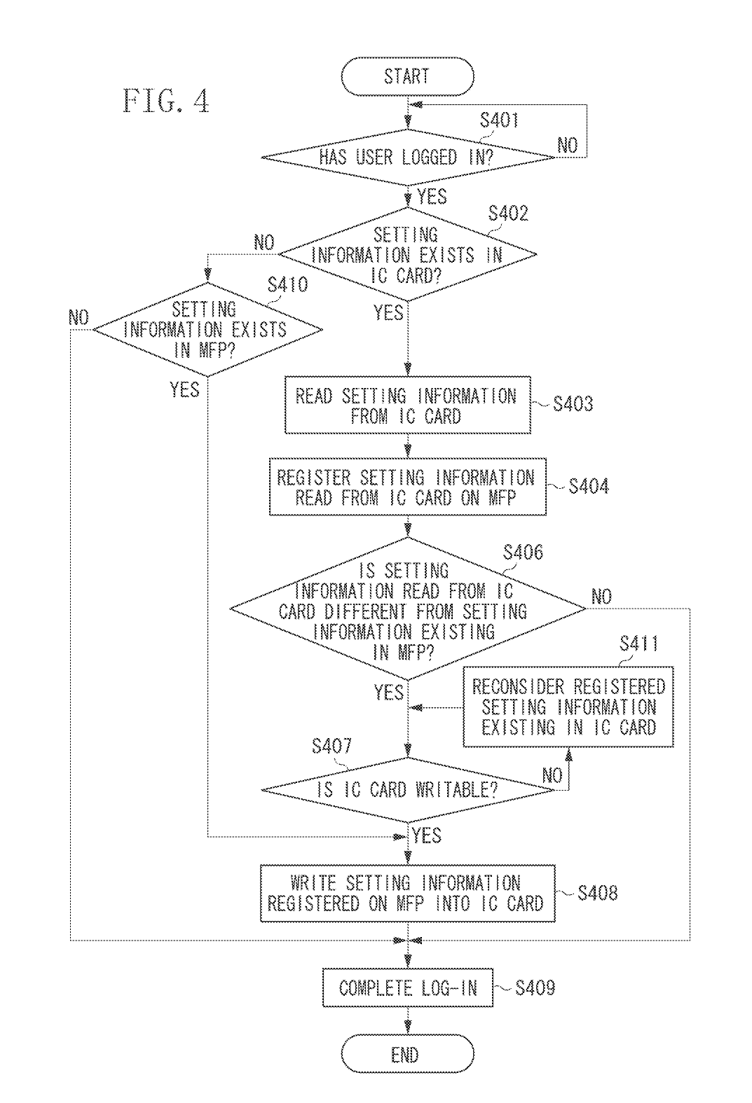

FIG. 4 is a flowchart illustrating a control method of the image forming apparatus 10 according to the present exemplary embodiment. In the control method according to the present exemplary embodiment, the user logs in the image forming apparatus 10 by using the IC card 100. Each step is realized when the CPU 301 executes a control program stored in the HDD 304.

In step S401, the CPU 301 determines whether the user has held the IC card 100 over the IC card reader/writer unit 15 to execute a log-in operation through the IC card reader/writer unit 15. The user information such as a user identification (ID) necessary for the log-in operation is stored in the IC card 100, and the CPU 301 reads the user information to execute log-in processing of the image forming apparatus 10. If the CPU 301 determines that the user has executed the log-in operation (YES in step S401), the CPU 301 executes the log-in processing by reading the user information from the IC card 100. Then, the processing proceeds to step S402.

In step S402, the CPU 301 determines whether registered customized setting information exists in the IC card 100 through the IC card reader/writer unit 15.

Here, the customized setting information registered on the IC card 100 will be described.

For example, a setting such as a scanning resolution setting, a one-sided/two-sided setting, or an N-up setting in which a plurality of pages is allocated and printed on a single sheet of paper is registered on the IC card 100 as the customized setting information.

For example, the user may register a two-sided/N-up setting as the frequently-used customized setting information for making a copy.

On the other hand, in a case where the user creates a portable document format (PDF) file by scanning an image on a document, the user may register a 600 dots-per-inch (dpi)/one-sided setting as the customized setting information for a scanning operation because the document is commonly printed in 600 dpi on one side.

In step S402, if the CPU 301 determines that the registered customized setting information exists in the IC card 100 (YES in step S402), the processing proceeds to step S403. On the other hand, if the CPU 301 determines that the customized setting information is not registered on the IC card 100 (NO in step S402), the processing proceeds to step S410.

In step S410, the CPU 301 determines whether registered customized setting information associated with the log-in user information acquired in step S401 exists in a customized setting information writing area within the HDD 304. If the CPU 301 determines that the customized setting information has already been registered (YES in step S410), the processing proceeds to step S408. On the other hand, if the CPU 301 determines that the registered customized setting information does not exist in the HDD 304 (NO in step S410), the processing proceeds to step S409. In step S409, the CPU 301 completes the log-in processing.

In step S403, the CPU 301 reads the customized setting information within the IC card 100 via the IC card reader/writer unit I/F 314 and the IC card reader/writer unit 15. After reading the customized setting information, the processing proceeds to step S404.

In step S404, the CPU 301 executes control processing for writing the customized setting information read from the IC card 100 in step S403 into the HDD 304. The written customized setting information is stored in the HDD 304 in association with the log-in user information acquired in step S401.

Here, because the HDD 304 has a predetermined area for writing the customized setting information, the CPU 301 executes control processing for writing all of the customized setting information into that area. When the CPU 301 has written the customized setting information read from the IC card 100 into the predetermined area within the HDD 304, the processing proceeds to step S406.

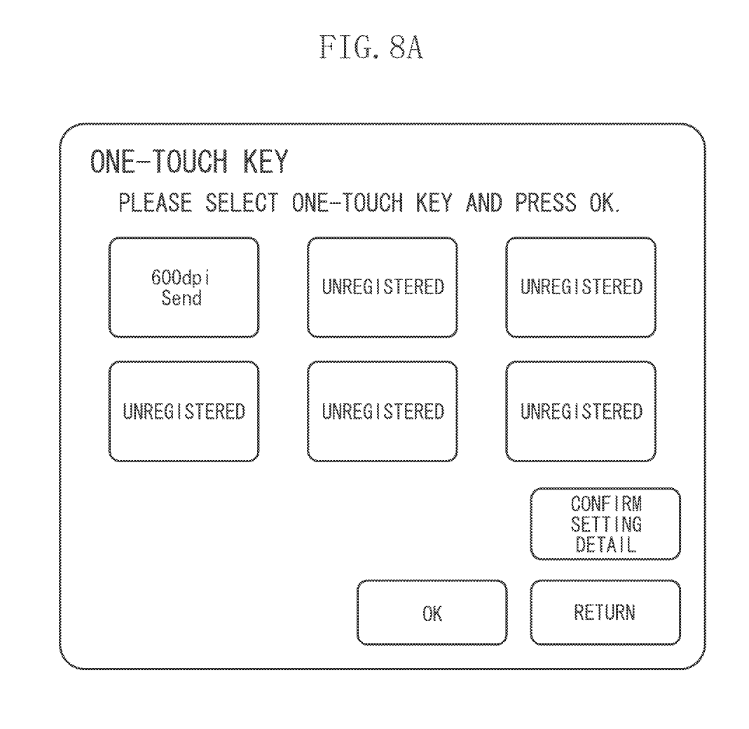

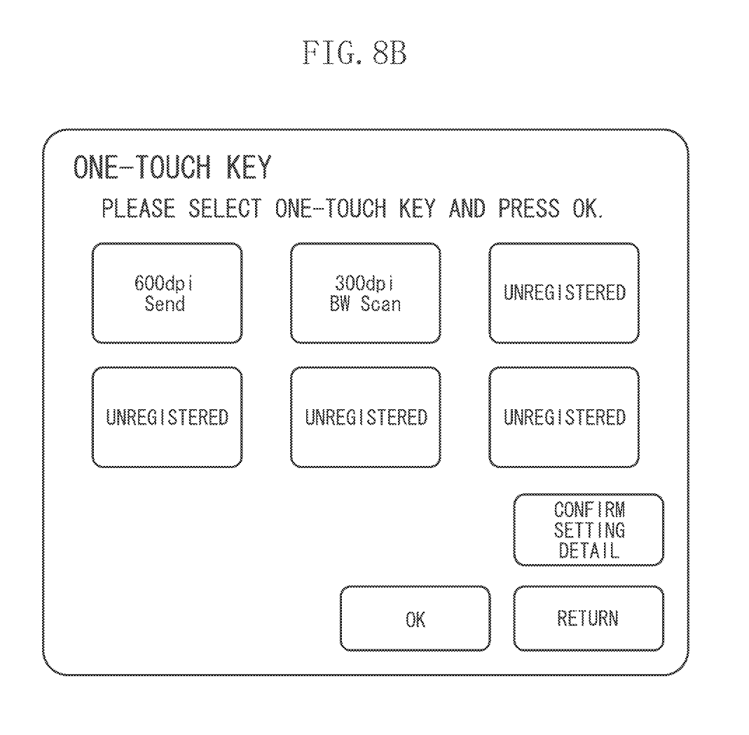

Here, examples of UI screens to be displayed when the customized setting information read from the IC card 100 is written into the HDD 304 in step S404 will be described with reference to FIGS. 8A and 8B.

FIGS. 8A and 8B are diagrams illustrating examples of the UI screens displayed on the operation unit 12 illustrated in FIG. 3. In particular, FIG. 8A is a diagram illustrating an example of the UI screen that is to be displayed when only one piece of registered customized setting information exists in the HDD 304 of the image forming apparatus 10.

In FIG. 8A, customized setting information of “600 dpi Send” is registered on a one-touch key at the upper left. It is assumed that the user logs in the above image forming apparatus 10 by using the IC card 100, while that IC card 100 stores the customized setting information used for a job “300 dpi/BW Scan”. Here, “BW” represents “black and white”. As illustrated in FIG. 8B, when the user executes the log-in operation with respect to the image forming apparatus 10, the customized setting information used for a job “300 dpi/BW Scan” stored in the IC card 100 is read and registered on a one-touch key at the upper center as the customized setting information. The one-touch key (i.e., setting button) for “300 dpi/BW Scan” is generated by the CPU 301. The CPU 301 executes control processing for displaying the generated button on the UI screen of the operation unit 12, so that the screen illustrated in FIG. 8B is displayed thereon. The screen illustrated in FIG. 8B functions as a screen for receiving a setting with respect to a job from the user.

Through the above processing, the user can use the customized setting stored in the IC card 100 on the image forming apparatus 10.

In step S406, the CPU 301 determines whether there is any difference between the customized setting information read from the IC card 100 in step S403 and the customized setting information already registered on the customized setting information writing area within the HDD 304. The CPU 301 compares respective pieces of customized setting information to determine whether there is any difference. If the CPU 301 determines that there is a difference (YES in step S406), the processing proceeds to step S407. On the other hand, if the CPU 301 determines that there is no difference (NO in step S406), the processing proceeds to step S409.

In step S407, in order to register the difference in customized setting information determined in step S406 on the IC card 100, the CPU 301 determines whether a memory for storing the customized setting information within the IC card 100 is a writable state. Specifically, the CPU 301 accesses the memory within the IC card 100 through the IC card reader/writer unit 15 to determine whether the memory is writable.

If the CPU 301 determines that the IC card 100 is writable (YES in step S407), the processing proceeds to step S408. On the other hand, if the CPU 301 determines that the IC card 100 is not writable because the memory is fully written and occupied by information (NO in step S407), the processing proceeds to step S411. In step S411, the CPU 301 reconsiders the information stored in the IC card 100.

Here, as a method for reconsidering the information, for example, there is provided a method in which all of the customized setting information stored in the IC card 100 is read and displayed on the operation unit 12 to allow the user to select and delete the unnecessary information. With the above method, the user can secure a storage region for storing new setting information within the IC card 100.

In addition, the customized setting information stored in the IC card 100 may be deleted in the order of the oldest information. Furthermore, use frequency of the customized setting information may be stored in the memory, so that the customized setting information may be deleted in the order of the least use frequency, and thus the customized setting information can be reconsidered in various manners.

In step S408, the CPU 301 executes control processing for writing the customized setting information registered on the image forming apparatus 10 into the IC card 100. At this time, because the log-in operation with respect to the image forming apparatus 10 has not been completed, the user is still holding the IC card 100 over the IC card reader/writer unit 15. Therefore, the CPU 301 executes the writing control processing by accessing the IC card 100 via the IC card reader/writer unit 15. At this time, the CPU 301 may write all of the customized setting information registered on the HDD 304 of the image forming apparatus 10, or may write only the customized setting information determined to be different in step S406. When the CPU 301 ends the writing processing of the IC card 100, the processing proceeds to step S409. In step S409, the CPU 301 completes the log-in processing of the image forming apparatus 10.

Through the above-described control processing flow, when the user logs in the image forming apparatus 10 by using the IC card 100, the user can register and use in the image forming apparatus 10 the customized setting information stored in the IC card 100. On the other hand, if the user registers the customized setting information stored in the image forming apparatus 10 on the IC card 100, the user can use the customized setting information that has been used only in the image forming apparatus 10, in another image forming apparatus 10 when the user uses the IC card 100 to log in the another image forming apparatus 10.

A second exemplary embodiment will be described. In the first exemplary embodiment, a processing flow for logging in the image forming apparatus 10 by using the IC card 100 has been described. In the processing flow illustrated in FIG. 4, at least there is no difference in the customized setting information registered on the image forming apparatus 10 and the customized setting information registered on the IC card 100 at the time of log-in.

However, there may be a case where the user executes customized setting which is not registered thereon in order to execute a job after the log-in. Therefore, a control processing flow that is to be executed when the image forming apparatus 10 has executed the job after the log-in will be described.

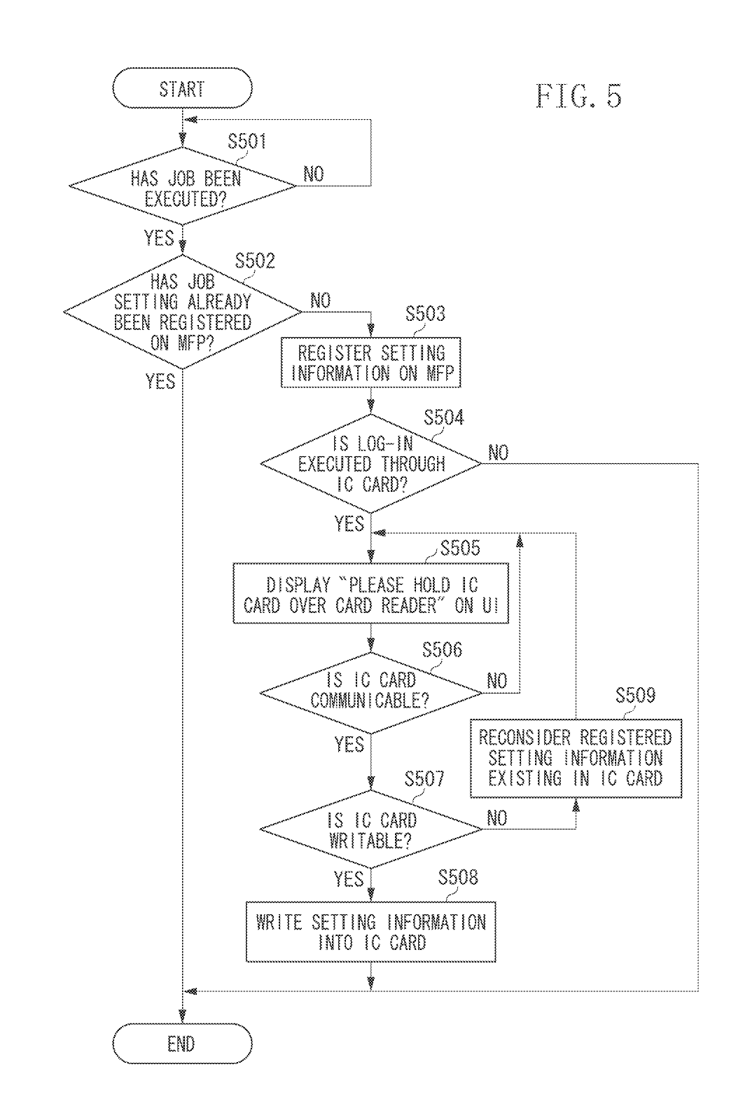

FIG. 5 is a flowchart illustrating a control method of the image forming apparatus 10 according to the present exemplary embodiment. In the control method according to the present exemplary embodiment, the user logs in the image forming apparatus 10 by using the IC card 100. Each step is realized when the CPU 301 executes a control program stored in the HDD 304.

In step S501, the CPU 301 determines whether the image forming apparatus 10 has executed any job. The job may be the processing control using a function included in the image forming apparatus 10 such as a copying or a scanning function. If the CPU 301 determines that the job has been executed (YES in step S501), the processing proceeds to step S502.

In step S502, the CPU 301 determines whether the job executed in step S501 is a job using the customized setting information already registered on the HDD 304 of the image forming apparatus 10. If the CPU 301 determines that the job is a job using the registered customized setting information (YES in step S502), the CPU 301 does not have to execute new registration because the same customized setting information has already been registered on the IC card 100 at the time of log-in. However, if the CPU 301 determines that the job is a job using a new customized setting information that has not been registered (NO in step S502), the processing proceeds to step S503.

In step S503, the CPU 301 firstly registers the customized setting information of the job executed in step S501 on the area for storing the customized setting information in the HDD 304. When the registration is executed on the one-touch key as illustrated in FIG. 8B, a registration operation may be executed so that the user is allowed to operate the operation unit 12 to input a name displayed on the one-touch key. When the customized setting information has been registered on the image forming apparatus 10, the processing proceeds to step S504.

In step S504, the CPU 301 determines whether the user has used the IC card 100 to log in the image forming apparatus 10. If the CPU 301 determines that the user has used the IC card 100 to log-in (YES in step S504), the processing proceeds to step S505.

On the other hand, if the CPU 301 determines that the user has operated the keys on the operation unit 12 to log-in instead of using the IC card 100 (NO in step S504), the CPU 301 ends the job.

In step S505, because the IC card 100 will be communicable and writable when the user holds the IC card 100 over the IC card reader/writer unit 15, the CPU 301 displays a message for prompting the user to hold the IC card 100 over the IC card reader/writer unit 15, on the operation unit 12. Then, in step S506, the CPU 301 determines whether the IC card 100 is communicable with the IC card reader/writer unit 15. In step S506, if the CPU 301 determines that the IC card 100 is communicable (YES in step S506), the processing proceeds to step S507.

In step S507, the CPU 301 communicates with the IC card 100 through the IC card reader/writer unit 15 and determines whether the customized setting information used in the latest job can be registered on the IC card 100. In step S507, if the CPU 301 determines that the IC card 100 is writable (YES in step S507), the processing proceeds to step S508.

On the other hand, if the CPU 301 determines that the IC card 100 is not writable (NO in step S507), the processing proceeds to step S509. In step S509, the CPU 301 reconsiders the customized setting information registered on the IC card 100. The control processing for reconsidering the information is the same as the control processing executed in step S411 illustrated in FIG. 4, and thus the detailed description thereof will be omitted.

In step S508, the CPU 301 registers the customized setting information of the job executed in step S501 on the IC card 100 through the IC card reader/writer unit 15.

Through the above-described control processing flow, when a job is executed by the image forming apparatus 10 while new customized setting information is used for the job, the customized setting information is stored in the image forming apparatus 10 and the IC card 100. With this configuration, even if the job using the new customized setting information is executed after the user has logged in the image forming apparatus 10, the customized setting information can be registered on the image forming apparatus 10 and the IC card 100.

A third exemplary embodiment will be described. In the above-described first and the second exemplary embodiments, the control processing flows of logging in the image forming apparatus 10 and registering the customized setting information by using the IC card 100 have been described. However, in a recent office environment, the user has increased opportunities to use mobile terminals such as a tablet terminal and a smartphone. A mobile terminal that supports a standard for non-contact communication within a distance of a few centimeters known as “near field communication (NFC)” has been increasingly used.

However, because the NFC is not suitable for transmission and reception of large volume of data, a method known as “handover” is generally employed in order to hand over the communication between devices to a wireless LAN (i.e., Wi-Fi) after pairing of the devices is firstly executed through the NFC.

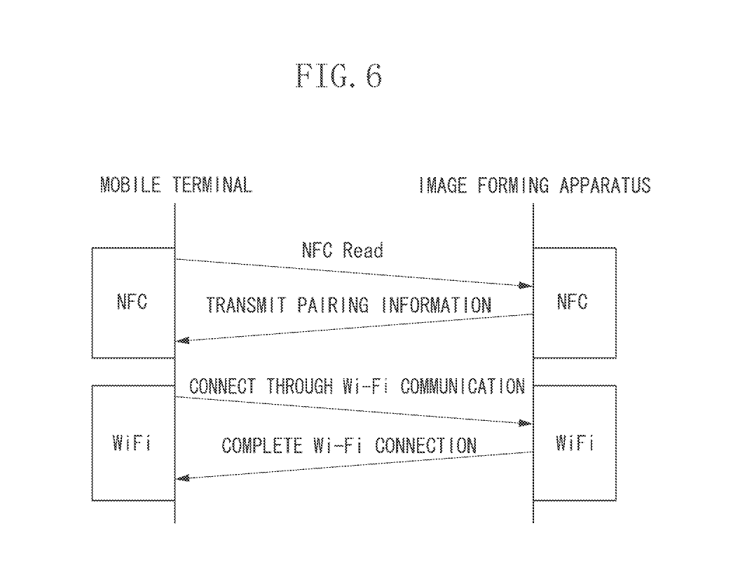

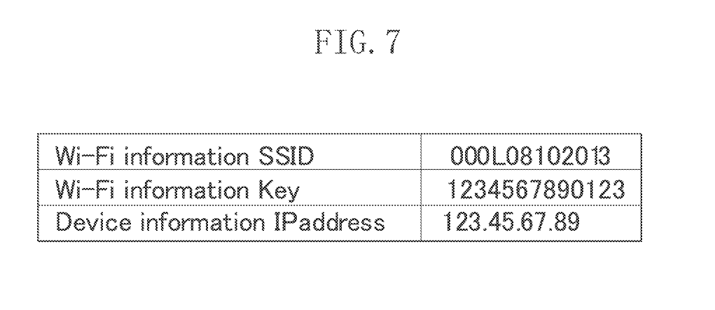

Therefore, in the present exemplary embodiment, the processing executed by using a mobile terminal such as a tablet terminal or a smartphone instead of using the IC card 100 will be described with reference to FIGS. 6 and 7.

FIG. 6 is a diagram illustrating a connection sequence executed between a mobile information terminal and an image forming apparatus.

In the present exemplary embodiment, the user firstly holds the mobile information terminal close to the IC card reader/writer unit 15 of the image forming apparatus 10, so that the CPU 301 detects the access via the NFC. Next, the CPU 301 transmits pairing information to the mobile information terminal through the IC card reader/writer unit 15. The mobile information terminal receives the pairing information and searches for the image forming apparatus 10 via the Wi-Fi communication. When the mobile information terminal executes the above searching operation, the CPU 301 accepts the Wi-Fi connection from the mobile information terminal to execute Wi-Fi connection control processing. As a result, the Wi-Fi connection is established between the mobile information terminal and the image forming apparatus 10.

Here, the pairing information transmitted to the mobile information terminal from the image forming apparatus 10 will be described in detail with reference to FIG. 7.

The pairing information is information necessary for connecting the mobile information terminal and the image forming apparatus 10 via the Wi-Fi communication, and the mobile information terminal that receives the pairing information can execute a device search operation based on the pairing information.

The Wi-Fi information such as a service set identifier (SSID) and a key, and the device information such as an internet protocol (IP) address are transmitted as the pairing information. FIG. 7 is a table illustrating a detailed example of the paring information transmitted thereto.

Through the above-described control processing flow, in a case where the user logs in the image forming apparatus 10 by using a mobile terminal, the customized setting information can be transmitted and received via the Wi-Fi communication because the Wi-Fi connection can be established therebetween. In other words, if the Wi-Fi connection is established between the image forming apparatus 10 and the mobile information terminal, the customized setting information can be transmitted and received even if the user does not hold the IC card 100 over the IC card reader/writer unit 15 intentionally.

Further, additional exemplary embodiment) are applicable to a system configured of a plurality of devices (e.g., a computer, an interface device, a reader, and a printer), or an apparatus configured of a single device (e.g., a multifunction peripheral, a printer, or a facsimile apparatus). Furthermore, another exemplary embodiment is applicable to a stand-alone apparatus which is not connected to the LAN 60.

Each processing step described in the present invention can be realized by causing a processing device (i.e., a CPU or a processor) of a personal computer (i.e., a computer) to execute software (i.e., a program) acquired through a network or various storage media.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure is not limited to the above-described exemplary embodiments, and various modifications and changes, including any combination of the exemplary embodiments, are possible based on the essential spirit of the present disclosure. Therefore, such modifications and changes are included in the scope of the present disclosure.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-128347, filed Jun. 23, 2014, which is hereby incorporated by reference herein in its entirety.

What is claimed is:

1. An image forming apparatus that executes at least near field wireless communication with a mobile apparatus, the image forming apparatus comprising:
a storage unit configured to store first setting information indicating a setting relating to reading or printing of an image for each user;
a reading unit configured to read user identification information indicating a user who uses the mobile apparatus and second setting information indicating a setting relating to reading or printing of an image from the mobile apparatus through the near field wireless communication; and
a writing unit configured to write, in the mobile apparatus, a difference between the first setting information stored in the storage unit corresponding to the user identification information read by the reading unit and the second setting information read by the reading unit.

2. The image forming apparatus according to claim 1,
wherein the first setting information and the second setting information are setting information indicating at least one of a scanning resolution setting, a two-sided printing setting, or an N-up setting in which a plurality of pages is allocated and printed on a single sheet of paper.

3. The image forming apparatus according to claim 1, further comprising:
a storage control unit configured to control the storage unit to additionally store a difference between the second setting information read by the reading unit and the first setting information stored in the storage unit corresponding to the user identification information read by the reading unit.

4. The image forming apparatus according to claim 3, further comprising:
a display unit configured to display the additionally stored difference.

5. The image forming apparatus according to claim 1 further comprising:
a wireless communication unit configured to execute wireless LAN communication by using pairing information transmitted to the mobile apparatus through the near field wireless communication,
wherein the writing unit writes the difference into the mobile apparatus through the wireless communication unit.

6. A control method for an image forming apparatus that executes at least near field wireless communication with a mobile apparatus, including a storage unit for storing first setting information indicating a setting relating to reading or printing of an image for each user, the control method comprising:
reading user identification information indicating a user who uses the mobile apparatus and second setting information indicating a setting relating to reading or printing of an image from the mobile apparatus through the near field wireless communication; and
writing, in the mobile apparatus, a difference between the first setting information stored in the storage unit corresponding to the user identification information read by the reading unit and the second setting information read by the reading unit.

7. A non-transitory computer readable storage medium storing a program for causing an image forming apparatus that executes at least near field wireless communication with a mobile apparatus, including a storage unit for storing first setting information indicating a setting relating to reading or printing of an image for each user, to execute a method, the method comprising:
reading user identification information indicating a user who uses the mobile apparatus and second setting information indicating a setting relating to reading or printing of an image from the mobile apparatus through the near field wireless communication; and
writing, in the mobile apparatus, a difference between the first setting information stored in the storage unit corresponding to the user identification information read by the reading unit and the second setting information read by the reading unit.
